(19) United States
(12) Patent Application Publication
(10) Pub. No.: US 2026/0019217 A1
(43) Pub. Date: Jan. 15, 2026

(54) COMMUNICATION APPARATUS

(71) Applicant: Fujitsu Limited, Kawasaki-shi (JP)

(72) Inventors: Takashi Kondou, Hiroshima (JP); Takeshi MATSUOKA, Hiroshima (JP); Tatsushi KANEMOTO, Hiroshima (JP)

(73) Assignee: Fujitsu Limited, Kawasaki-shi (JP)

(21) Appl. No.: 19/250,214

(22) Filed: Jun. 26, 2025

(30) Foreign Application Priority Data
Jul. 10, 2024 (JP) 2024-111213

(51) Int. Cl. H04L 5/00; H04W 76/18

(52) U.S. Cl. CPC H04L 5/0073; H04W 76/18

(57) ABSTRACT

A communication apparatus in a communication system that includes a plurality of communication apparatuses of an active system and a standby communication apparatus of a standby system includes: a communicator configured to transmit and receive communication apparatus information including information related to the communication apparatus to and from the other communication apparatuses; and a controller configured to compare a degree of impact on communication of the communication apparatus with a degree of impact on communication of each of the other communication apparatuses based on the communication apparatus information, and to start, when the degree of impact of the communication apparatus is determined to be high, synchronization processing that transmits synchronization data to be used in operation to the standby communication apparatus.

### CROSS-REFERENCE TO RELATED APPLICATION

This application is based upon and claims the benefit of priority of the prior Japanese Patent Application No. 2024-111213, filed on Jul. 10, 2024, the entire contents of which are incorporated herein by reference.

### FIELD

The present disclosure relates to a communication apparatus.

### BACKGROUND

In recent years, wireless communication systems are configured with various apparatuses. When any of the apparatuses included in a wireless communication system fails and function abnormally, wireless communication of corresponding terminal devices may be affected. Therefore, a redundancy method may be adopted in wireless communication systems.

One example of the redundancy method is a one-to-one method in which one unit of a standby system (SBY system) is prepared for one unit of an active system (ACT system).

Another example of the redundancy method is an N+M method in which M (M is a natural number, and N>M) units of a standby system are prepared for N (N is a natural number) units of an active system.

For example, techniques related to the redundancy methods in systems are described in Japanese Patent Application Publication No. H11-098058; Japanese Patent Application Publication No. H04-113726; Japanese Patent Application Publication No. S58-202630; and WO 2011/077948.

### SUMMARY

In the one-to-one method, data of the active system is always copied to the standby system. In this way, when a failure occurs in the active system, the active system can be switched to the standby system in a short time, and the impact on the wireless communication can be reduced. However, the one-to-one method prepares the same number of units of the standby system as the number of units of the active system, which increases the cost.

On the other hand, compared with the one-to-one method, the N+M method can reduce the number of units of the standby system, which can reduce the cost. However, in the N+M method, when the active system fails, processing such as software installation and data copying is performed on the standby system, and thus, it takes time to start up a new active system, which has a significant impact on wireless communication.

A communication apparatus in a communication system that includes a plurality of communication apparatuses of an active system and a standby communication apparatus of a standby system, the communication apparatus includes, a communication unit configured to transmit and receive communication apparatus information including information related to the communication apparatus to and from the other communication apparatuses; and a control unit configured to compare a degree of impact on communication of the communication apparatus with a degree of impact on communication of each of the other communication apparatuses based on the communication apparatus information, and to start, when the degree of impact of the communication apparatus is determined to be high, synchronization processing that transmits synchronization data to be used in operation to the standby communication apparatus.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 illustrates a configuration example of a communication system 10.

FIG. 2 illustrates a configuration example of the DU 300.

FIG. 3 illustrates an example of a sequence of the standby system preparation procedures.

FIG. 4 illustrates an example of a processing flowchart of the impact-degree determination processing S11.

FIG. 5 illustrates an example of comparison items.

FIG. 6 illustrates an example of the synchronization data.

FIG. 7 illustrates an example of a sequence of the failure response procedures.

### DESCRIPTION OF EMBODIMENTS

### Embodiment 1

Embodiment 1 will be described.

### Configuration Example of Communication System 10

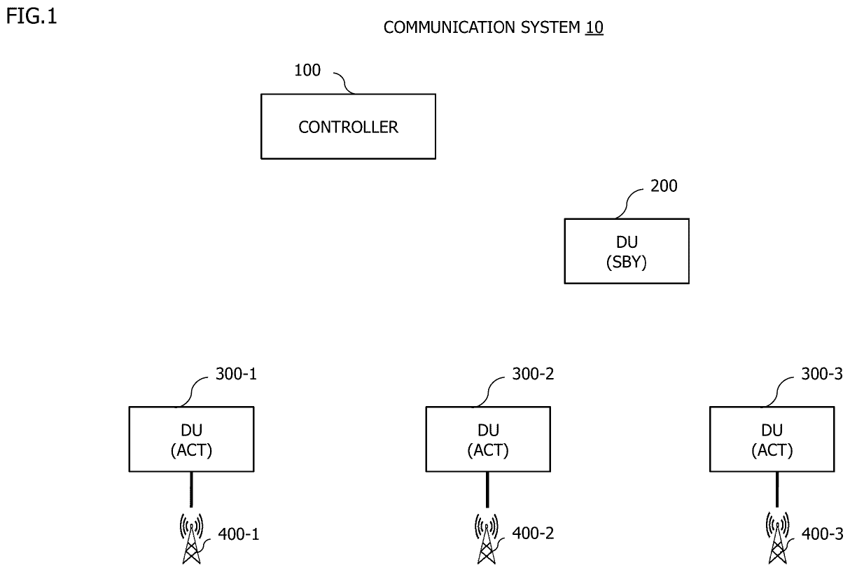

FIG. 1 illustrates a configuration example of a communication system 10. The communication system 10 includes a controller 100, a distributed unit (DU) 200 of a standby system, and three DUs 300-1 to 300-3 (hereinafter, may be referred to as “DUs 300”) of an active system. Hereinafter, a DU of the standby system may be referred to as a “DU (SBY)”, and a DU of the active system may be referred to as a “DU (ACT)”. In the communication system 10, as an example of an apparatus configuration using the redundancy method, three DUs of the active system are provided for one DU of the standby system. However, for example, as in an N+M method, the communication system 10 may include M DUs of the standby system for N DUs of the active system. Hereinafter, the DU 200 and the DU 300 may be simply referred to as communication apparatuses. That is, the communication apparatuses include both a DU (SBY) and a DU (ACT). The apparatuses are connected to each other via a network (not illustrated) and can communicate with each other.

The controller 100 is a controller that controls the active system and the standby system, and is, for example, a server machine or a computer machine. For example, the controller 100 deletes Pod from a DU (ACT) in which a failure has occurred, or creates Pod for a DU (SBY) to be switched to the active system. Pod is a unit of an application container, and includes, for example, an application and a database for appropriately operating the communication apparatus. In addition, creating Pod includes, for example, downloading an application or data to a communication apparatus and making the communication apparatus operable. Further, deleting Pod includes deleting the application or data downloaded to the communication apparatus and setting the communication apparatus to a state (stop state) in which the communication apparatus is unable to operate.

The DU 200 and the DU 300 are, for example, communication apparatuses (communication control apparatuses) each of which includes one or more radio units (RUs) under its control. For example, the DU 300-1 includes an RU 400-1 under its control, the DU 300-2 includes an RU 400-2 under its control, and the DU 300-3 includes an RU 400-3 under its control. Each of the RUs 400-1 to 400-3 establishes a cell (communication area), and is wirelessly connected to terminal devices located within its coverage area so as to perform wireless communication.

The DU 200 is a DU (SBY), which is a standby system. When the DUs 300-1 to 300-3 operate normally, the DU 200 is installed in the communication system 10 as a standby system. When a failure occurs in any of the DUs 300-1 to 300-3, the DU 200 replaces the failed DU 300 and becomes a DU (ACT).

The DU 300 is a DU (ACT), which is an active system. The DU 300 may switch between the active system and the standby system under the control of the controller 100, for example.

In the communication system 10, the DUs (ACT) 300-1 to 300-3 notify each other of their own information, for example, periodically. Details of the notified information will be described below. Each of the DUs (ACT) 300-1 to 300-3 determines its own importance based on the information received from the other DUs (ACT) 300, and when any of the DUs (ACT) 300-1 to 300-3 determines that the degree of its own impact (importance) is high, this DU (ACT) 300 synchronizes with the DU (SBY) 200, and prepares the DU (SBY) 200 as its own standby system. The degree of impact refers to, for example, the magnitude of impact on wireless communication in the communication system 10, and details of the determination will be described below.

In the communication system 10, the DU (ACT) 300 having a high degree of importance is selected, and its data is synchronized with the DU (SBY) 200 before a failure occurs. Thus, when a failure occurs, the standby system can be switched to the active system in a short time so that the impact on communication is reduced.

### Configuration Example of DU 300 (200)

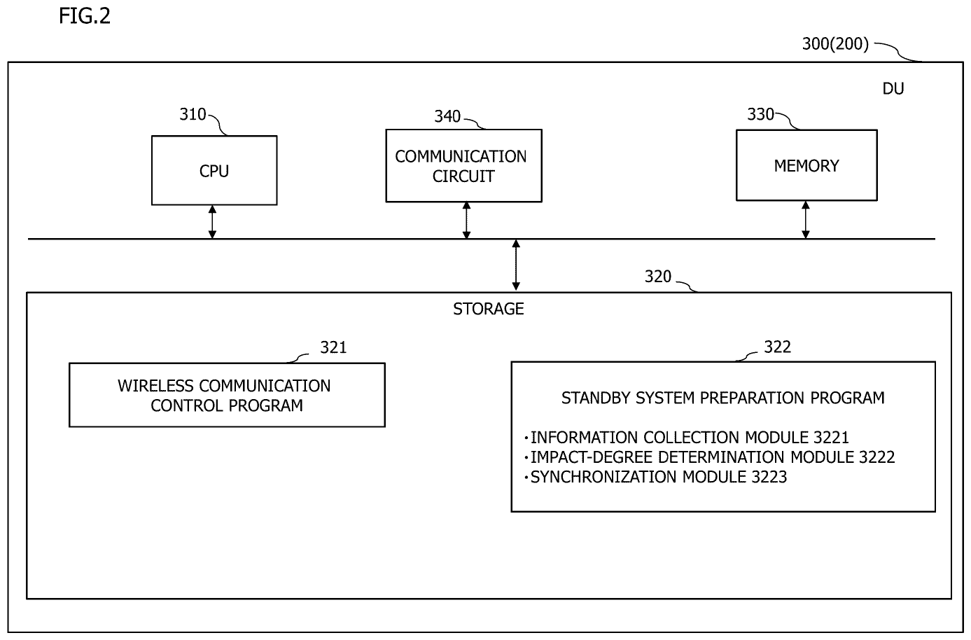

FIG. 2 illustrates a configuration example of the DU 300. It is assumed that the DU 200 and the DU 300 have the same hardware configuration. The programs illustrated in FIG. 2 are programs in the active system, and indicate states after the Pod has been switched (created).

The DU 300 includes a central processing unit (CPU) 310, a storage 320, a memory 330, and a communication circuit 340.

The storage 320 is an auxiliary storage device such as a flash memory, a hard disk drive (HDD), or a solid-state drive (SSD) that stores programs and data. The storage 320 stores a wireless communication control program 321 and a standby system preparation program 322.

The memory 330 is an area into which the programs stored in the storage 320 are loaded. The memory 330 may also be used as an area in which the programs store data.

The communication circuit 340 is a device that communicates with other devices. The communication circuit 340 may be a wired communication circuit such as a network interface (NI) or a communication circuit corresponding to wireless connection. Further, a plurality of communication circuits 340 may be installed, for example, for connection to the RU 400 and for connection to other communication apparatuses (the DU 200, the DU 300, and the controller 100).

The CPU 310 is a processor that loads the program stored in the storage 320 into the memory 330, executes the loaded program, constructs units, and implements processes.

The CPU 310 performs a wireless communication control process by executing the wireless communication control program 321. The wireless communication control process is a process for controlling wireless communication performed by the terminal devices included in the communication system 10. For example, the wireless communication control process controls the RU 400 under the CPU 310.

The CPU 310 constructs a communication unit and a control unit by executing the standby system preparation program 322, and performs standby system preparation procedures. The standby system preparation procedures are performed to prepare the DU (SBY) 200 as a standby system for the DU 300 when the degree of impact of the DU 300 is higher than (the highest of, or relatively high among) those of the other DUs 300. The standby system preparation procedures include information collection processing, impact-degree determination processing, and synchronization processing.

The CPU 310 constructs the communication unit by executing an information collection module 3221 included in the standby system preparation program 322, and performs the information collection processing. The information collection processing is processing for transmitting DU information to the other DUs 300 and receiving DU information from the other DUs 300. The information collection processing is performed, for example, periodically. The DU 300 recognizes the other DUs 300 in the same group, which includes the DU 200 as a standby system. For example, the DUs 300-1 to 300-3 recognize that the DUs 300-1 to 300-3 belong to the same group, and that the DU 200 is the standby system of their own group. When any of the other DUs 300 fails and the DU 200 is switched to serve as the active system as a substitute, the DU 300 recognizes that the DU 200 is in the same group, and thereafter performs the information collection processing with the DU 200. The DU information will be described in detail below.

The CPU 310 constructs the control unit by executing an impact-degree determination module 3222 included in the standby system preparation program 322, and performs the impact-degree determination processing. The impact-degree determination processing is processing for determining the degrees of impact of the DU 300 and the other DUs 300. The degree of impact refers to the magnitude of impact on wireless communication, for example, refers to the number of terminal devices located in the cell of the RU 400 under the DU 300.

The CPU 310 constructs the control unit by executing a synchronization module 3223 included in the standby system preparation program 322, and performs the synchronization processing. The synchronization processing is processing in which the CPU 310 periodically or non-periodically transmits its own synchronization data to the DU 200. The synchronization processing is executed, for example, when the degree of impact of the DU 300 is larger than those of the other DUs 300. The synchronization data will be described in detail below.

### Standby System Preparation Procedures

The standby system preparation procedures are steps of preparing for a failure of the DU 300, and the steps include determining the DU 300 having the highest degree of impact among a plurality of DUs 300, associating the determined DU 300 with the DU 200, and performing synchronization processing.

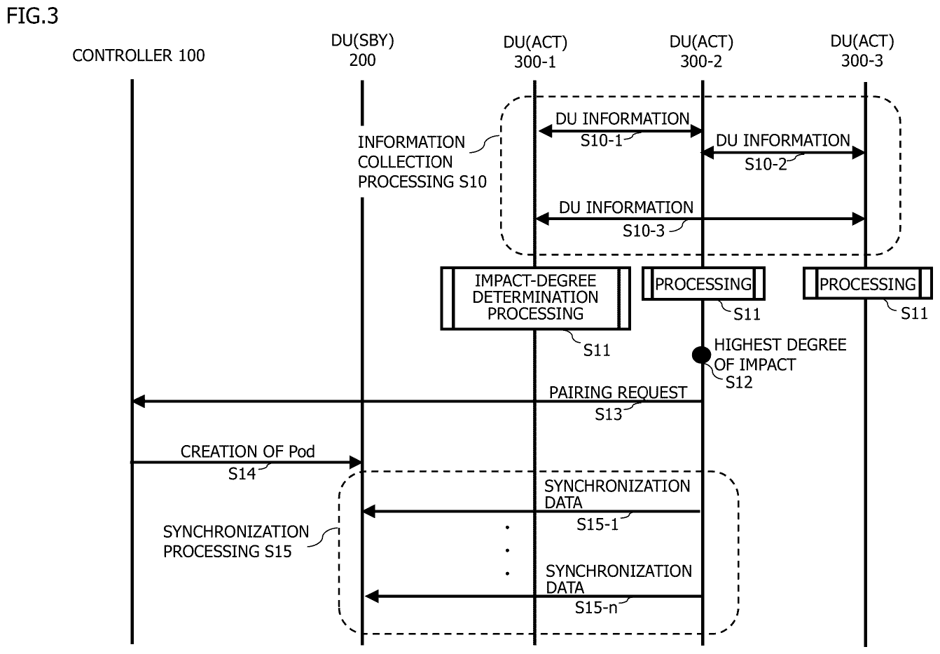

FIG. 3 illustrates an example of a sequence of the standby system preparation procedures. It is assumed that, among the DUs 300-1 to 300-3, the DU 300-2 has the largest number of in-range UEs.

The DUs (ACT) 300-1 to 300-3 recognize each other's identifiers, Internet Protocol (IP) addresses, and the like, and further recognize that the DUs 300-1 to 300-3 belong to one group, which includes the DU 200 as a standby system.

The DUs (ACT) 300-1 to 300-3 each perform information collection processing S10. The information collection processing S10 is, for example, periodically executed, and is processing for transmitting DU information to each other (S10-1 to S10-3).

The DU information is information related to a DU, and includes, for example, the number of terminal devices that are in range or that are currently performing communication, the volume of communication traffic, the number of accommodated cells, the CPU usage rate (load), and the like. Each of the DUs 300-1 to 300-3 transmits its own DU information to the other DUs 300.

The DU (ACT) 300 receives DU information, and when the DU (ACT) 300 has received all the DU information from the other DUs (ACT) 300 in the same group, the DU (ACT) 300 executes the impact-degree determination processing S11. The impact-degree determination processing S11 is processing for determining (estimating, calculating) the degree of impact of a failure of the DU 300 based on the DU information.

The impact-degree determination processing S11 is performed by each DU 300 periodically, for example, at predetermined intervals in accordance with transmission and reception of the DU information. The predetermined interval may be determined on the basis of the information collected as DU information, for example. The predetermined interval is shorter when the update frequency of the information is higher, and the predetermined interval is longer when the update frequency is lower. In addition, the DU 300 does not need to transmit or receive the same type of information as the DU information every time. Therefore, the time interval between the transmission or reception of DU information and the next transmission or reception of DU information may differ depending on the type of information included in the DU information.

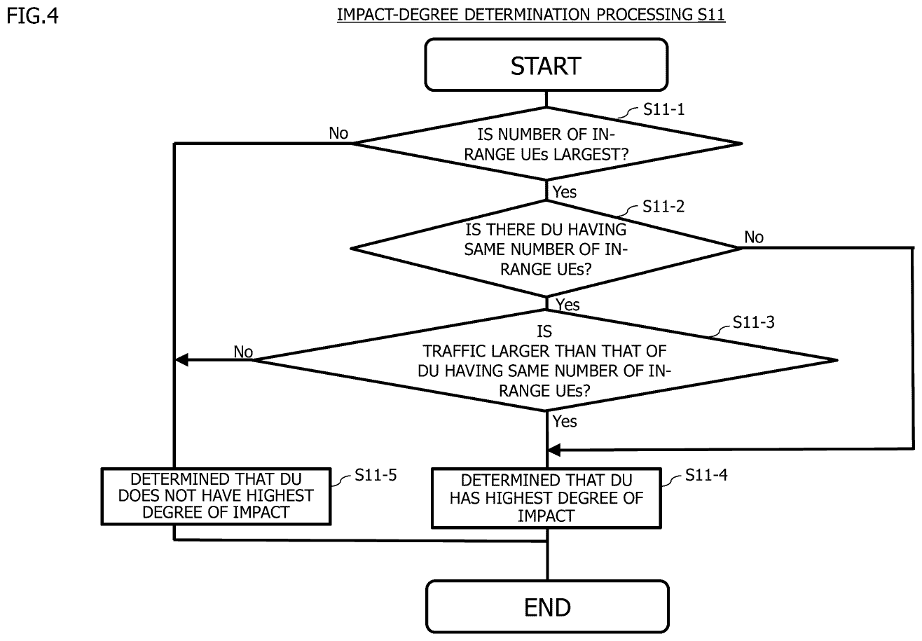

FIG. 4 illustrates an example of a processing flowchart of the impact-degree determination processing S11. The DU 300 determines whether the number of UEs (terminal devices) located within its coverage range is the largest compared with those of the other DUs 300 (S11-1).

The DU 300 determines whether there is any other DU 300 having the same number of UEs located within its coverage range (S11-2). If there is another DU 300 having the same number of in-range UEs (Yes in S11-2), the DU 300 determines whether the traffic of the DU 300 is larger than the traffic of the other DU 300 having the same number of in-range UEs (S11-3).

If the traffic of the DU 300 is larger than that of the other DU 300 having the same number of in-range UEs (Yes in S11-3), the DU 300 determines that the DU 300 has the highest degree of impact (S11-4), and the processing ends.

In addition, in step S11-2, if there is no other DU 300 having the same number of in-range UEs (No in S11-2), the DU 300 determines that the DU 300 has the highest degree of impact (S11-4), and the processing ends.

Further, in step S11-3, if the traffic of the DU 300 is not larger than that of the other DU 300 having the same number of in-range UEs (No in S11-3), and in step S11-1, if the number of in-range UEs is not the largest (No in S11-1), the DU 300 determines that the DU 300 does not have the highest degree of impact (S11-5), and the processing ends.

Note that the traffic refers to, for example, downlink and/or uplink data traffic (bps: bits per second) per cell. Although it is assumed to be rare that two different DUs 300 have completely the same traffic, there could be a case where both the number of in-range UEs and the traffic are completely the same. In this case, another comparison item may be added.

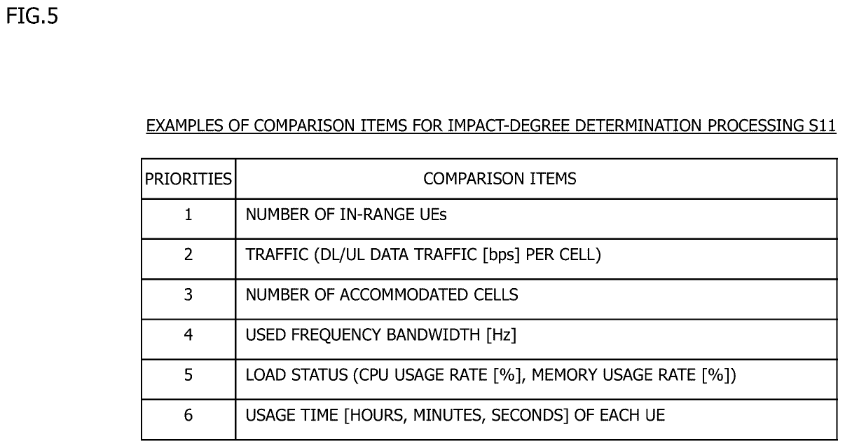

FIG. 5 illustrates an example of comparison items. The processing flowchart in FIG. 4 is an example in which the items of Priorities 1 and 2 are used. The DU 300 may further add the number of accommodated cells, which is Priority 3, the used frequency bandwidth, which is Priority 4, the load status (for example, the CPU usage rate, the memory usage rate, or the like), which is Priority 5, the average or total of the usage time of each UE, which is Priority 6, etc., as comparison items. It is assumed that the DU information includes information corresponding to each comparison item.

In addition, the DU 300 may select some of these comparison items, assign a score to each of the selected comparison items, and determine the degree of impact by using the total value or the average value of the scores, for example.

Returning to the sequence in FIG. 3, the DU 300-2 determines that the DU 300-2 has the highest degree of impact among the DUs 300 (S12). In this step, the other DUs 300-1 and 300-3 determine that the DUs 300-1 and 300-3 do not have the highest degree of impact among the DUs 300.

The DU 300-2 transmits a pairing request to the controller 100 (S13). The pairing request is a message requesting to prepare the DU (SBY) 200 as a standby apparatus for the DU 300-2.

When the controller 100 receives the pairing request (S13), the controller 100 creates a Pod for the DU 200 (S14). When the Pod has been created for the DU 200, the DU 200 prepares to be a standby system for the DU 300-2.

Thereafter, the DU 300-2 and the DU 200 perform the synchronization processing S15, for example, periodically. The synchronization processing S15 is processing for transmitting synchronization data to be used, to the DU 200 (S15-1, S15-n) so that the DU 200 can operate as a substitute for the DU 300-2 in as short a time as possible when a failure occurs in the DU 300-2. The synchronization data includes data to be used for operation or data needed for operation in the active system.

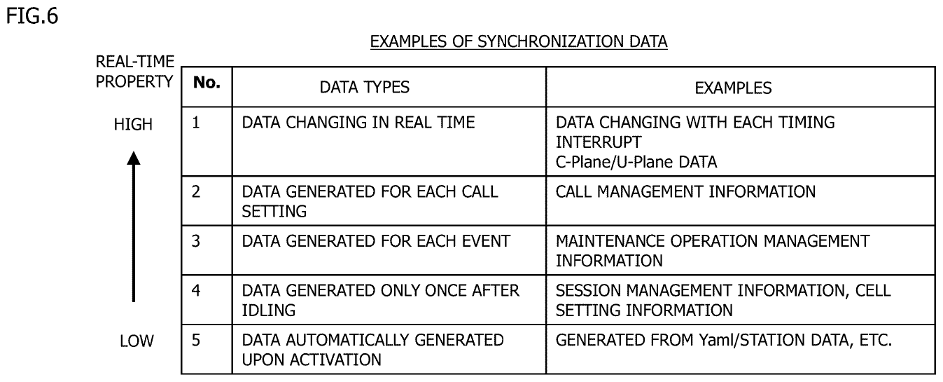

FIG. 6 illustrates an example of the synchronization data. In FIG. 6, the smaller the data number is, the higher the real-time property is.

The DU 300 transmits, for example, data 2 through data 4 as synchronization data. The data 2 is generated for each call setting. The data 2 is generated when a call is set up (when a wireless communication connection is established) for a terminal device (hereinafter, may be referred to as an “in-range terminal device”) that performs wireless communication with the RU 400 under the control of the DU 300, and includes, for example, call management information.

The data 3 is generated for each event. The data 3 is generated when an event, such as reception of a maintenance command, is received, and includes, for example, maintenance operation management information.

The data 4 is data generated only once after idling. The data 4 is generated only once after idling, and includes, for example, session management information and cell setting information. The term “after idling” includes, for example, when the system is switched from the standby system to the active system, when operation is started after the DU 300 is installed, and the like. Unlike data 5, the data 4 is not data that is automatically generated at the time of Pod switching (including, for example, at the time of restarting after downloading an application), but data that is generated in initial processing performed after normal activation.

The reason why the data 1 is not included in the synchronization data is that the data that changes in real time changes very frequently, and if all of such data are transmitted to the DU 200, the amount of data and the number of transmissions will increase, and the communication load will be applied to the entire communication system 10.

The reason why the data 5 is not included in the synchronization data is that the data generated at the time of activation is generated when the Pod is created, and therefore, there is no need to transmit the data.

The transmission is performed, for example, when a change (update) occurs in the data to be transmitted. The synchronization data may be classified into data types and transmitted on the basis of the data types, or all of or some of the types of synchronization data may be collectively transmitted.

In addition, if the frequently updated type of data (for example, data generated at each call setting) is transmitted at each update, the number of transmissions will increase. Therefore, such a type of data may be transmitted periodically or may be transmitted when the data has been updated a certain number of times.

Further, the DU 300 may detect data-synchronization timing by using, for example, a function (for example, lsyncd or rsync) of the operating system (OS) of the DU 300. The DU 300 may specify a file or a directory including the synchronization data and detect a change in the specified file or directory by using the function of the OS, and the time at which the change is detected may be set as the transmission timing of the synchronization data.

### Failure Response Procedures

Failure response procedures will be described. Hereinafter, a case where the DU 300-2 having the highest degree of impact fails (damage occurs) will be described. Note that, in a case where the DU 300-1 or 300-3, which does not have the highest degree of impact, fails, the procedures as in the N+M method are performed, for example.

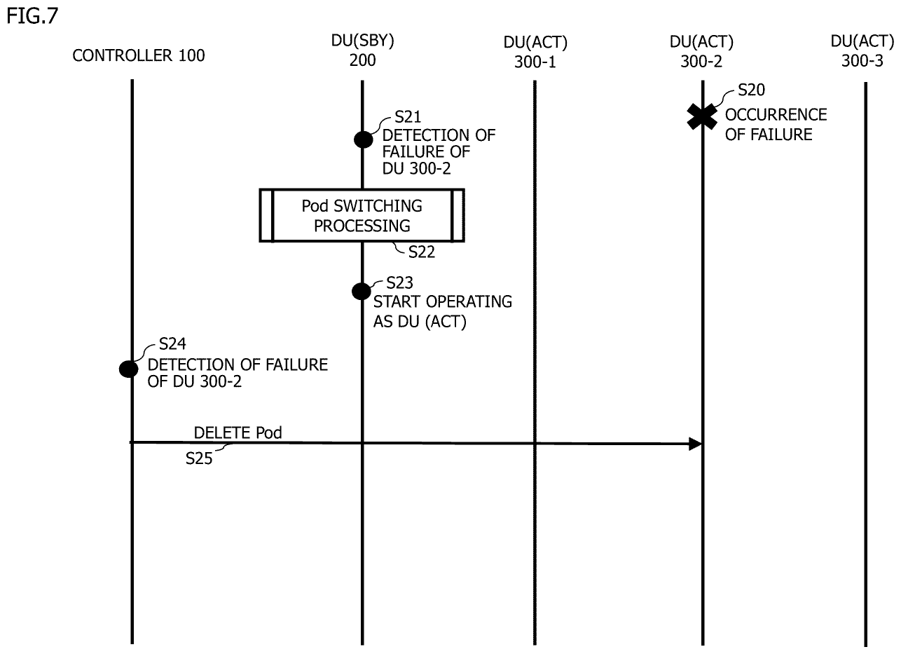

FIG. 7 illustrates an example of a sequence of the failure response procedures. A failure has occurred in the DU 300-2 (S20).

The DU 300-2 and the DU 200 perform health checks, for example, by periodic polling. It is assumed that the DU 200 can detect the failure of the DU 300-2 by performing this health check.

The DU 200 detects the failure of the DU 300-2 (S21). Having detected the failure (S21), the DU 200 performs Pod switching processing (S22). The Pod switching processing S22 is processing for replacing the failed DU 300-2 with the DU 200, which has been on standby as a standby system, and switching to the active system. The DU 200 starts operating as a DU (ACT) (S23). For example, the DU 200 starts controlling the RU 400 under the DU 200, and starts communicating with a higher-level device (for example, a control unit (CU)).

The controller 100 also detects that the DU 300-2 has failed (S24). The controller 100 can detect the failure of the DU 300-2, for example, through a health check or the interruption of the communication for a certain period of time. Having detected the failure of the DU 300-2 (S24), the controller 100 deletes the Pod from the DU 300-2 (S25). For example, the Pod deletion is processing for deleting the application and date of the DU 300-2, which has been the active system. For example, when the failure of the DU 300-2 is repaired, and the DU 300-2 returns to a state in which normal operation can be performed, the DU 300-2 may be on standby as a standby system.

In Embodiment 1, a DU 300 having a high degree of impact performs data-synchronization with a standby system. Thus, even when the DU 300 having a high degree of impact fails, the DU 300 can be switched to the standby system in a short time. Further, the standby system is not prepared for a DU 300 having a smaller degree of impact, the number of standby systems can be reduced, and thus, the cost can be reduced.

### Other Embodiments

In Embodiment 1, three units of the active system are provided for one unit of the standby system. However, Y units (Y is an integer larger than X) of the active system may be provided for X units (X is an integer of 2 or more) of the standby system. In this case, the degrees of impact of Y units are ranked within the active system, and the top X units of the active system in the ranking are associated with the standby system to perform the synchronization processing. In this way, the active system is associated with the standby system in descending order of the degrees of impact. As a result, the standby system can be efficiently prepared.

According to one disclosure, the impact on communication can be reduced while the redundancy cost is reduced.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A communication apparatus in a communication system that includes a plurality of communication apparatuses of an active system and a standby communication apparatus of a standby system, the communication apparatus comprising:
a communicator configured to transmit and receive communication apparatus information including information related to the communication apparatus to and from the other communication apparatuses; and
a controller configured to compare a degree of impact on communication of the communication apparatus with a degree of impact on communication of each of the other communication apparatuses based on the communication apparatus information, and to start, when the degree of impact of the communication apparatus is determined to be high, synchronization processing that transmits synchronization data to be used in operation to the standby communication apparatus.

2. The communication apparatus according to claim 1, wherein the controller periodically executes the comparing.

3. The communication apparatus according to claim 1,
wherein the communication apparatus information includes a number of terminal devices under the communication apparatus, and
wherein the controller determines that a degree of impact of the communication apparatus is high when the number of terminal devices under the communication apparatus is greater than a number of terminal devices under the other communication apparatus.

4. The communication apparatus according to claim 3,
wherein the communication apparatus information includes a numerical value related to traffic volume of the communication apparatus, and
wherein, in a case where a second communication apparatus is included in the other communication apparatus, the second communication apparatus having an equal number of terminal devices under the second communication apparatus to a number of terminal devices under the communication apparatus, the control unit determines that a degree of impact of the communication apparatus is high when the traffic volume of the communication apparatus is greater than traffic volume of the second communication apparatus.

5. The communication apparatus according to claim 1, wherein the standby communication apparatus replaces the communication apparatus, and is switched to serve as an active system when the standby communication apparatus detects that a failure has occurred in the communication apparatus.

6. The communication apparatus according to claim 1, wherein the synchronization data includes data generated when communication with a terminal device under the communication apparatus is established.

7. The communication apparatus according to claim 1, wherein the synchronization data includes data generated when an event occurs.

8. The communication apparatus according to claim 1, wherein the synchronization data includes data generated only once when operation starts.

9. The communication apparatus according to claim 1,
wherein the communication system includes a second controller that manages the active system and the standby system, and
wherein, when the controller determines that a degree of impact of the communication apparatus is high, the controller notifies the second controller of the determination.

10. A communication system comprising:
a plurality of communication apparatuses of an active system; and
a standby communication apparatus of a standby system,
wherein each of the communication apparatus transmits and receives communication apparatus information including information related to the communication apparatus to and from the other communication apparatuses, compares a degree of impact on communication of the communication apparatus with a degree of impact on communication of each of the other communication apparatuses based on the communication apparatus information, and starts, when the degree of impact of the communication apparatus is determined to be high, synchronization processing that transmits synchronization data to be used in operation to the standby communication apparatus, and
wherein the standby communication apparatus receives the synchronization data in the synchronization processing, replaces, when the standby communication apparatus detects that a failure has occurred in the communication apparatus that has transmitted the synchronization data, the communication apparatus that has transmitted the synchronization data, and is switched to serve as an active system.
